(19) United States
(12) Patent Application Publication
(10) Pub. No.: US 2007/0139659 A1
(43) Pub. Date: Jun. 21, 2007

(54) Device and method for capturing speckles

(76) Inventors: Yi-Yuh Hwang, Taoyuan City (TW); Ming Chen, Tao-Yuan (TW); Mau-Ran Wang, Taipei City (TW); Wen-Chen Huang, Taipei City (TW); Shin-I Ma, Tao-Yuan (TW)

Correspondence Address: RABIN & Berdo, PC, 1101 14TH STREET, NW, SUITE 500, WASHINGTON, DC, 20005, US

(21) Appl. No.: 11/300,488

(22) Filed: Dec. 15, 2005

(51) Int. Cl. G01B 11/14

(52) U.S. Cl. 356/614

(57) ABSTRACT

A method and device for capturing speckles are described. A highly coherent light emitted from a light source is used to illuminate a surface and produces scattered lights. The scattered lights pass through a light restrictive element and the diffracted lights produced by this restrictive element interfere with one another to generate a speckle pattern. An image sensor is then used to pick up the speckle pattern to form a speckle image. Therefore, the effects of diffraction and interference and a light restrictive element to enlarge the speckle size and reduce the variation of the speckle pattern during the movement of the imaging device are utilized, so that the speckle pattern can be clearly identified in the image. As a result, the method and device for capturing speckles are fairly stable and sensitive.

### BACKGROUND OF THE INVENTION

1. Field of Invention

The present invention relates to the application of relative motion detection utilizing a coherent light source and improved speckle pattern imaging configuration and technique.

2. Description of Related Art

Laser is a light source with high coherence. When two highly coherence lights close to each other and the optical path difference (OPD) is less than the coherent length, they will interfere with each other. There are constructive and destructive interferences, where the former produces bright fringes while the latter produces dark fringes. Therefore, the interference between two coherent light beams often produces a pattern with alternating bright and dark fringes. Moreover, the interference is related to the wavelength of the light. When two beams overlap, a destructive interference occurs if the phase difference is half the wavelength, whereas a constructive interference occurs if the phase difference is an integer multiple of the wavelength. As a result, the detecting precision is half of a wavelength. Since the wavelength of the laser light is fairly short (for example, the wavelengths of visible light range from 0.3 to 0.7 μm), the half-wavelength precision is very sensitive. Therefore, interference effect has a number of applications.

When a highly coherent light is projected on a rough surface, the light is strongly scattered to all directions. When two highly coherent lights close to each other and the OPD is less than the coherent length, the interference occurs and a pattern of many bright and dark spots is formed. It is the origin of laser speckles.

Speckles that are not related to displacement of the light source are considered as noises and these noises will deteriorate the image quality. However, it is discovered that speckles that are correlated with displacement of the light source can be used as a measurement means. Lately, the characteristics of speckles that are correlated with displacement of the light source were used to detect the relative motion of the navigator. For example, U.S. Pat. No. 20050024623 (hereinafter referred as the patent 623) discloses an optical displacement method and device. An embodiment of patent 623 uses a coherent light source to emit a coherent beam toward a surface and the light beam is then reflected by and leaves the surface. A sensor is disposed in the path of the specular reflected light and the reflected beam received by the sensor contains a speckle pattern with a number of speckles within this speckle pattern. Correlation of successive narrow bandwidth scatter pattern images is typically used to determine the displacement of the relative movement.

Another related technique is the patent in the PCT Pat. No. WO2004075040 (hereinafter referred as the patent 040). It discloses an optical signal processing method and device for optical mice with digital data processing. The relative displacement vector between the laser beam signal of the mouse and the surface of the object that generates the speckle is calculated by collecting the moving signal of the speckle. The device used to implement the idea includes an opto-electrical signal amplifying and rectifying module, a direction-determine and counting module, and a computer interface in the mouse. It further includes a laser source and an opto-electrical sensor, in which the sensor is used for receiving the speckle signals of the reflected laser lights from object surface. The opto-electrical sensor sends the received opto-electrical signal to amplify and rectify module.

The above-mentioned signal reading means are based upon the variation in speckle brightness in the image captured by the sensor, thereby calculating the moving direction and distance of the mouse. The 040 patent has a simple structure. However, if the reflecting surface is very smooth, then the size of the produced speckle is much smaller. Therefore, it is difficult to detect the variation in the speckle brightness. In that case, the resolution is decreased much, rendering a lower sensitivity.

The 623 patent mainly uses the sensor to receive the reflective beam equal to the specular reflection. Therefore, the signals received by the sensor can be divided into direct current (DC) and alternating current (AC) parts. The DC part refers to the uniform distribution of the reflected lights. The brightness variation of the speckle belongs to the AC part. When the size of the speckle is too small, the AC part is hard to be extracted and analyzed.

In summary, the sensitivity is determined by the size of speckle. Speckles with small size cannot be effectively identified. Therefore, how to control the size of the speckle and reduce the variation of speckle pattern during the movement of the displacement sensor are the keys to increase the sensitivity.

### SUMMARY OF THE INVENTION

This invention relates to the application of relative motion detection utilizing a coherent light source and improved speckle pattern imaging configuration and techniques. The purpose of this invention is to provide a device and method for controlling and measuring speckle images in displacement monitory applications. When the scattered lights bouncing off a surface illuminated by a beam of coherent light source are allowed to pass through a small light restrictive aperture, diffraction phenomenon occurs. The diffracted optical waves originated from adjacent lights passing through the aperture interfere with one another to produce larger speckle than that without small aperture. This size-enlargement effect makes it possible for the detector array to register each speckle spot with more certainty and determine the movement of the pattern with better accuracy. The relative motion between the surface and the beam source—detector assembly can be calculated by comparing the position changes of speckle pattern from consecutive picture frames taken by the detector unit.

In accordance with the invention, it is also important the lights scattered into the detector array must be limited to a small enough area from the illuminated surface. A combination of lens and aperture, or apertures, will serve the purpose by limiting the incident angle of the scattered lights. Constricting the coherent source beam through a suitable beam-shaping unit to achieve a small illumination spot can further help the same purpose.

To achieve the above object, a speckle imaging device disclosed by the invention has a light source that emits a highly coherent light onto a surface to produce scatter lights. The scattered lights pass through a small-aperture light restrictive element and then diffracted by this aperture. The diffracted lights interfere with one another to produce a speckle pattern. Finally, the sensor picks up the speckle pattern to form a speckle image.

Besides, a light shrink unit may be used to reduce the diameter of the highly coherent light emitted by the light source. Alternatively, a light converging means can be used to minimize the diameter of the beam incident on the object surface so as to increase the dynamical range that can be analyzed from the moving speckle patterns.

Another embodiment of speckle imaging method of the present invention emits a highly coherent light onto a surface to produce scatter lights. The scattered lights pass through a small-aperture light restrictive element and then generate a diffractive effect. The diffractive lights interfere with one another to produce a speckle pattern. Finally, the speckle pattern is recorded to form an image.

After recording the speckle pattern that is produced at present to form an image, a further step is to compare this image to the previous image that is already obtained during the motion of the image sensor thereby the movement of the sensor assembly relative to the surface can be determined.

After the step of emitting a highly coherent light, the method further includes the step of reducing the diameter of the highly coherent light.

Alternatively, after the step of generating scattered lights by projecting a highly coherent light onto a surface, the method further includes a step of passing the scattered lights through an aperture to restrict the incident angle of the scattered lights.

Thus, to detect the motion of a sensor assembly relative to an object surface, good sensitivity requires that the image of the speckle pattern must be clear and stable. Besides, the speckles themselves must be sufficiently large in size and have a high contrast relative to the background in order to be easily identified. Moreover, the variation of the speckle pattern during the motion of sensor assembly relative to the reference surface must be sufficiently small for the convenience of identification. The present invention utilizes the diffraction and interference effects to enlarge the size of speckle, and limits the incident angle of the scattered lights to reduce the variation of the speckle image. Thus, the speckle image is clear and has little variation during the motion of sensor assembly relative to the reference surface for a certain distance. Therefore, the disclosed device and method for capturing speckle pattern are both stable and sensitive.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIGS. 1A, 1B, and 1C show the system structure of the invention;

FIG. 2 is a schematic view of the diffraction phenomenon produced by the light restrictive element in the invention;

FIG. 3 is a schematic view of the speckle formed by the invention;

FIG. 4 shows the motion of the speckle according to the invention;

FIGS. 5A and 5B are schematic views showing the optical path difference (OPD) in the invention;

FIGS. 6A, 6B, and 6C are schematic views of the light reduce unit in different embodiments of the invention;

FIG. 7A is a schematic view of adding a secondary aperture to the invention;

FIG. 7B is a schematic view showing that the incident angle of the scattered lights entering the sensor is limiting by the restrictive aperture of the present invention.

FIG. 8 is a schematic view of showing an application of the invention; and

FIGS. 9A, 9B and 9C are flowcharts of the speckle capturing method.

### DETAILED DESCRIPTION OF THE INVENTION

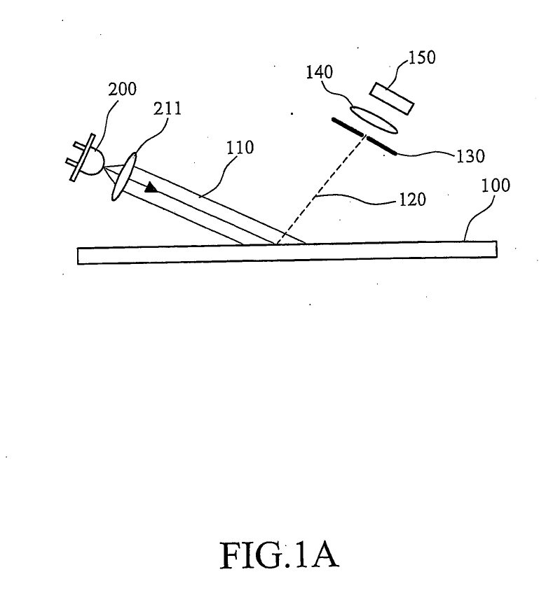

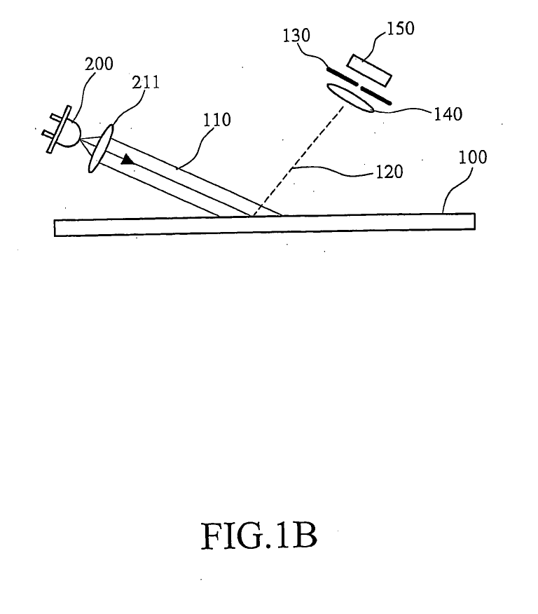

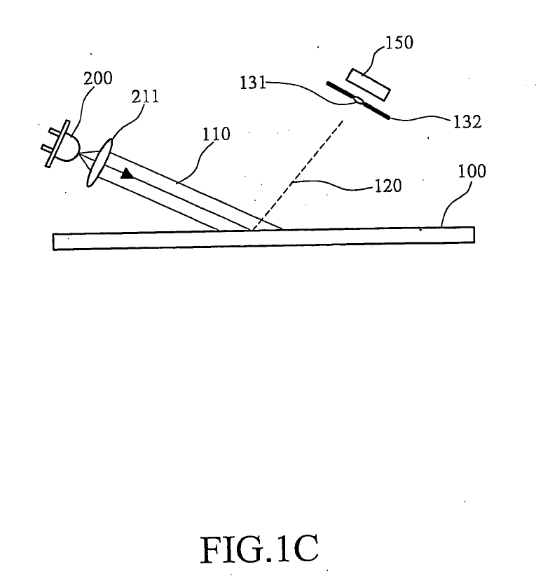

The system structure of the present invention is illustrated in FIG. 1A. When a light emits onto a surface 100, the properties of the reflected lights are determined by the roughness of the surface 100. The smoother the surface 100 is, the more mirror-like the surface 100 will be. In that case, the incident light 110 is almost totally reflected, with the reflected energy nearly the same as the incident energy. The rougher the surface 100 is, the foggier the surface 100 will be. After projecting onto the rough surface 100, the light is scattered almost in all directions. This is because the surface 100 is so rough that the lights propagate in arbitrary directions due to the scattering effect.

After the incident light 110 projects onto the surface 100, a lens 140 and an image sensor 150 are used to receive the scattered lights 120. In order to enlarge the speckle, a light restrictive element is disposed in front of the image sensor 150. The light restrictive element is a combination of an aperture 130 and a lens 140. The aperture 130 controls the size of speckles and can be disposed in front of the lens 140, as shown in FIG. 1A, or the aperture can be disposed between the lens 140 and the image sensor 150, as shown in FIG. 1B. Beside, the position and diameter of the aperture 130 in FIG. 1B will not only control the size of the speckle but limit the incident angle of the scattered lights 120. In this embodiment, the sensor is a two-dimensional array, such as charge couple device (CCD) or complementary metal oxide semiconductor (CMOS), for capturing images.

Alternatively, the aperture may be replaced by a microlens 131, featured that a light block plate 132 is placed around the microlens 131 to serve as a light restrictive element, as shown in FIG. 1C. (Since the diameter of the microlens 131 is small, it provides the effect of the aperture 130.) The scattered lights pass through the microlens 131 and diffracting by this microlens 131 that will control the size of speckles. The microlens 131 also functions as a lens 140 to form an image on the image sensor 150. In the following paragraphs, how the light restrictive element enlarges the size of speckles is described.

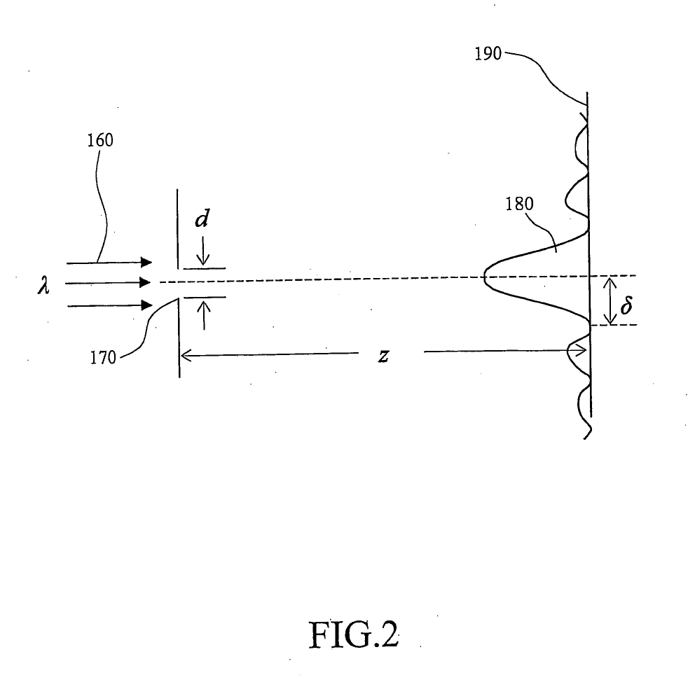

FIG. 2 shows the diffractive pattern of scattered lights passing through a light restrictive element. When a highly coherent light 160, such as laser light, passes through small-diameter aperture 170, diffraction occurs. Therefore, the light forms several concentric rings on the screen 190 due to diffraction. The central one represents a maximum and forms a bright spot 180 of lateral width 2δ. The half-width δ of the bright spot 180, the wavelength λ of light wave, the diameter d of the aperture 170, and the distance Z between the aperture 170 and the screen 190 satisfy the following relation:

$$δ = 1.22 \frac{λ}{d} z$$

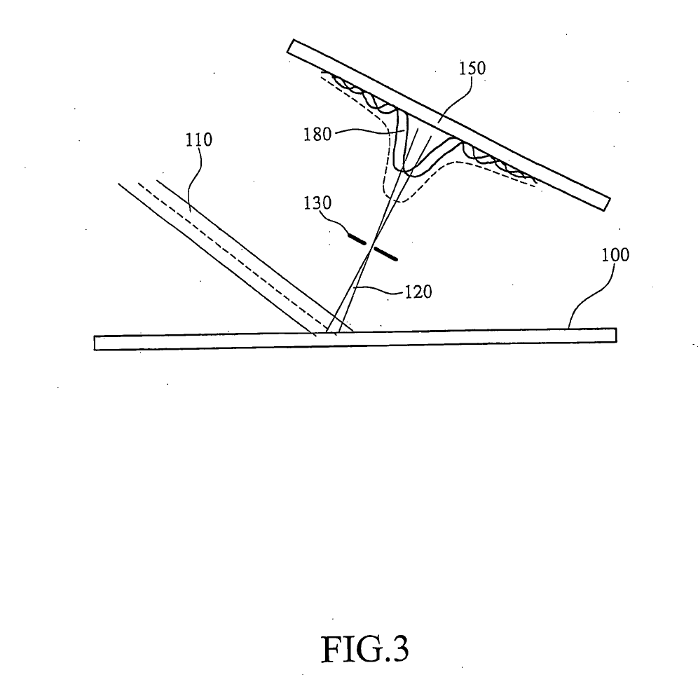

FIG. 3 shows that the scattered lights 120 created from different adjacent scattering centers on the illuminated surface. Each ray of the scattered lights 120 passes through the light restrictive element. The light restrictive element is implemented using an aperture 130 of small diameter, resulting in the diffractive effect of the incoming light. Therefore, different bright spots 180 interfere with one another resulting in an interlaced distribution of bright-and-dark spot that forming a speckle pattern. Diffraction theory predicts larger speckle size will be created by smaller aperture. Therefore, it becomes much easier to extract the motion of the speckle pattern using an image sensor.

In the disclosed system structure, the scattered lights passing through the light restrictive aperture and diffracted by the aperture, thereby make the size of speckle larger than that of the minimal resolving element of the image sensor array. Therefore, the sensor may accurately display the shape of the speckle and determine the motion of the speckle pattern during the movement of the sensor relative to an object surface.

Since the position of the speckle pattern at the image sensor 150 changes as the surface 100 moves, the speckle pattern has to remain roughly the same before and after the surface 100 moves in order to tell the direction and amount of the position change of each speckle spot. However, the speckle pattern is formed by the interference of the scattered lights 120 reflected from the uneven surface 100. Thus, the pattern of the speckle varies during the relative motion of the image sensor 150 relative to the surface 100. But, the speckle pattern variation is continuous instead of discrete. If the variation of the speckle pattern is reduced during the movement of the image sensor relative to the surface, the speckle patterns have strong correlations within a certain moving range when the speckle image sensor 150 moves relative to the surface 100. Therefore, it is possible to determine the motion of the speckle pattern by comparing the speckle images at sequential picture frames thereby determining the direction and distance of the displacement of the speckle captured device.

The light source emits highly coherent light. The most commonly seen highly coherent light is a laser. Therefore, the light source can be a vertical cavity surface emitting laser (VESEL), an edge emission laser (EEL), or a light emitting diode (LED) that can emit highly coherent light with a narrow band filter.

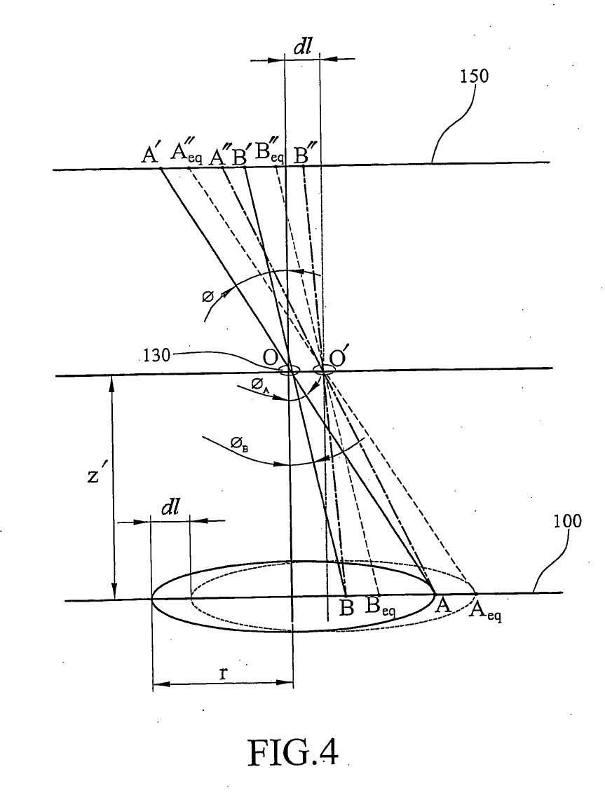

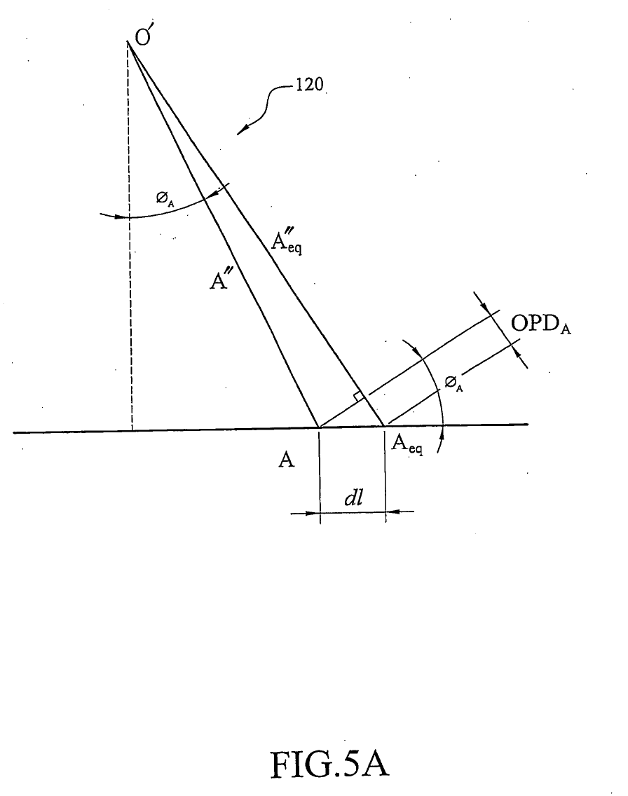

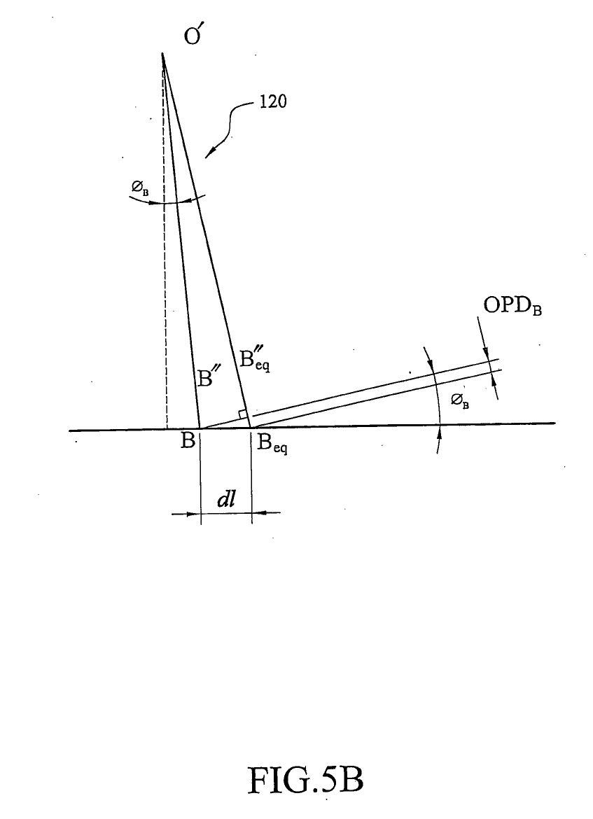

FIG. 4 shows how the speckle moves in accordance with the invention. When the aperture 130 is not moving, the scattered lights 120 from point A and point B form images at point A′ and point B′, respectively, on the image sensor 150 via point O of the aperture 130. When the aperture 130 moves a distance dl, the illuminated region also moves a distance dl accordingly, then the scattered lights 120 from point A and point B form images at point A″ and B″ on the image sensor 150 via point O′ of the aperture 130. As the aperture 130 moves a distance dl, the region on the surface 100 that is illuminated by light beam also moves in the same direction a distance dl. The point in the new illuminated region equivalent to point A of the original illuminated region is called point A_{eq}. The point in the new illuminated region equivalent to point B of the original illuminated region is called point B_{eq}. The scattered lights from point A_{eq} and point B_{eq} form images at point A_{eq}″ and point B_{eq}″, respectively, on the image sensor 150 via point O^{?} of the aperture 130. Since the image sensor 150 and the aperture 130 move together, therefore, for the image sensor 150 the paths A to A′ and A_{eq} to A_{eq}″ are geometrically equivalent. Points A and A_{eq} should form images at the same position on the image sensor 150. In other words, for the image sensor 150, points A′ and A_{eq} ″ fall on the same pixel while points B′ and B_{eq}″ fall on the same pixel. Observing the speckle image from the image sensor 150 after the image sensor moves, the characteristic image of point A has moved from the original point A_{eq} ″ to point A″. Likewise, the characteristic image of B also moves from point B_{eq} ″ to point B″. Therefore, it is possible to determine the displacement relation between points A_{eq} ″ and A″ and between points B_{eq}″ and B″ by comparing the speckle patterns, thereby determining the direction and distance of the displacement of the image sensor 150 relative to the surface 100. The change caused by moving from point A_{eq}″ to point A″ and from point B_{eq}″ to point B″ represents the position change of the image in geometric optics. However, the change in the intensity of the laser speckles measured at point A″ or B″ is related to the optical path difference (OPD) caused by the variation in the reflected optical paths. With reference to FIGS. 5A and 5B, we compare the optical path of point A after image sensor moving (that is the path between A and A″) and the equivalent optical path of point A before image sensor moving (that is the path between A_{eq} and A_{eq}″) and compute the OPD_{A} which is the OPD_{A} between A-A″ and A_{eq}-A_{eq}″. The moving distance dl of the aperture 130, the OPD_{A}, and the incident angle ψA, defined by the angle between the scattered lights 120 from point A and the normal of the aperture, satisfy the following relation:
OPD_{A}? dl sin φ_{A}

Therefore, the moving distance dl of the aperture 130, the OPD_{B}, and the incident angle ψB, defined by the angle between the scattered lights 120 from point B and the normal of the aperture, satisfy the following relation:
OPD_{B} ? dl sin φ_{B}

If ψ_{A} is equal to ψ_{B}, then OPD_{A} is equal to OPD_{B}. This means that the phase distributions of the speckle patterns before and after the movement of the sensor assembly relative to the surface are invariant, which in turn means that the intensity distributions of the speckle patterns do not change before and after the movement of the sensor assembly relative to the surface. If ψ_{A} and ψ_{B} are not equal to each other then OPD_{A} is not equal to OPD_{B}. If their difference exceeds a critical value, the speckle pattern after the motion deforms so much that it is quite different from the speckle pattern before the motion. If that is the case, the speckle pattern obtained after the motion of the sensor could not be recognized. How much difference between OPD_{A} and OPD_{B} can be tolerated such that the speckles do not deform too much depends on the roughness of the surface 100. Experimental results show that the maximum OPD tolerable of an aluminum or copper plate is much larger than that of a plastic plate or smooth photo paper. Although the maximum tolerable OPD is different when different surface and coherent light source are used, the maximum tolerable OPD for the same coherent light source 200 and the same surface 100 is a constant.

Therefore, the change in the OPD is related to the incident angle ψ of the scattered lights 120 and the displacement of aperture 130 combined with the image sensor 150. The incident angle ψ is in turn related to the radius r of the illuminated region and the distance Z′ between the aperture 130 and the surface 100:

$$tan ϕ = \frac{r}{z} ,$$

If the incident angle ψ is very small,

$$ϕ ? \frac{ r}{{Z}^{′}} .$$

Moreover, if the maximum tolerable OPD is a constant and the distance Z′ between the aperture 130 and the surface 100 is held constant, the need to reduce the incident angle ψ means that r has to be reduced. This indicated that the illuminated region has to be reduced. In this case, the shape of the speckle pattern can be maintained within a certain range of motion and it remains recognizable. That is, when we move the speckle imaging device with respect to a surface within a certain limited range, the shape of the speckle will not change or changes very little so that it still recognizable. Since the speckle imaging device has a displacement, the image of the new speckle pattern is thus formed at another position of the image sensor after the movement of the sensor assembly. Therefore, the direction and distance of the movement of the speckle imaging device can be determined by recording the consecutive images of the speckle patterns during movement followed by comparing these images consecutively.

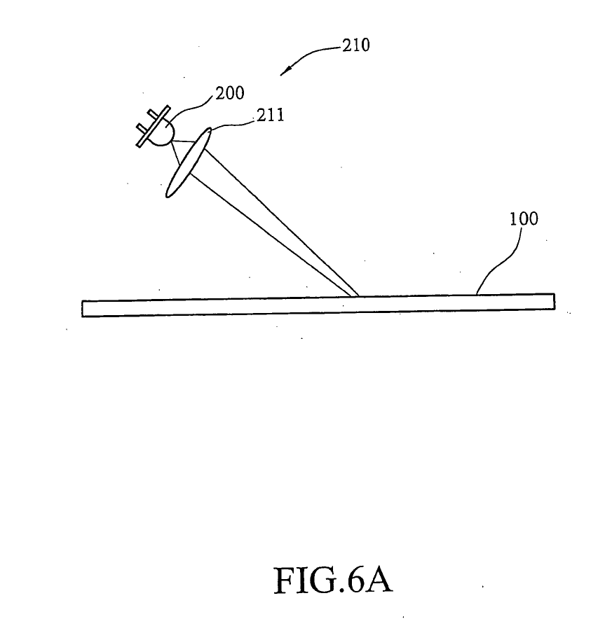

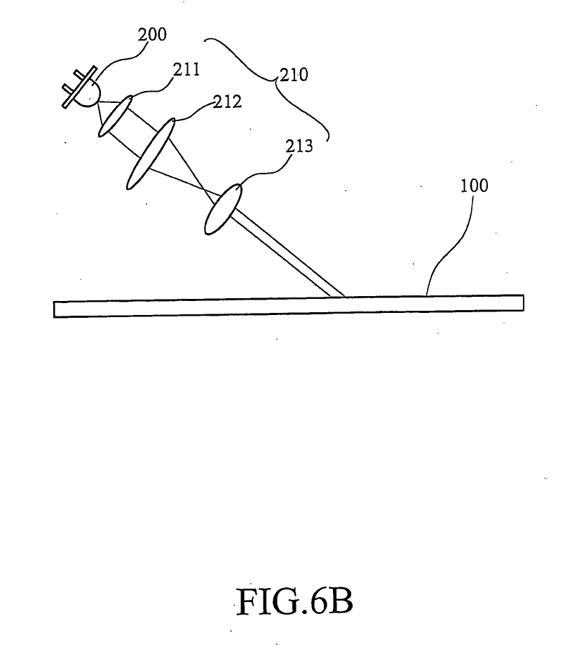

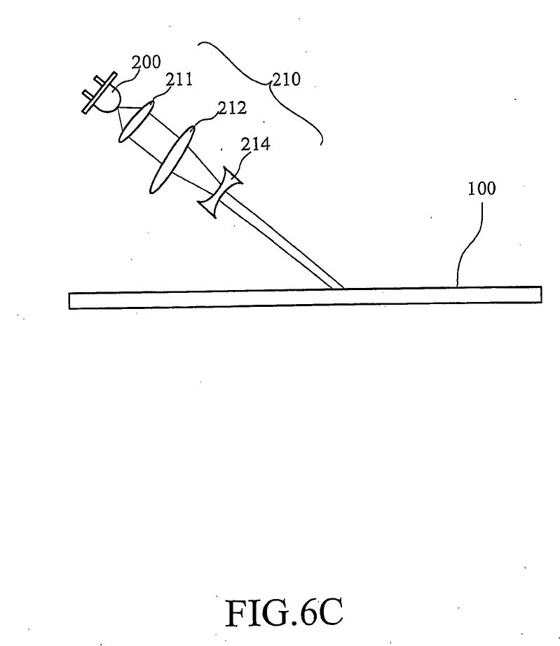

To achieve such a condition, the diameter of the incident beam has to be reduced. Embodiments of the present invention place a beam reducing unit 210 close to the light emitting source and serve as to reduce the diameter of the incidence beam as it project onto the surface 100, referring to FIGS. 6A, 6B, and 6C. In one of the embodiments, a convergent lens 211 is disposed in front of the light source 200 and the light emitted from the light source 200 will be converged when passing through the convergent lens 211, as shown in FIG. 6A. Therefore, when the surface 100 is close to the focal point of this convergent beam, the illuminated region is small. Alternatively, when the convergent lens 211 is disposed in front of the light source 200 for converting the highly coherent light into a collimated beam, one may dispose a first convergent lens 212 combined with a second convergent lens 213, whose focal points coincide. The focal lengths of the first lens 212 and the second lens 213 are f1 and f2, respectively. When f2<f1, the diameter of the incident beam is reduced by a factor of f1/f2, as shown in FIG. 6B. Yet another solution is to use a first lens 212 and a third lens 214 to form a beam reducing unit 210 with the third lens 214 is a divergent lens. When the focal points of the first lens 212 and the third lens 214 coincide, the incident beam also shrinks as it goes through the two lenses system that is constructed by lenses 212 and 214. This scheme has a smaller distance between the first lens 212 and the third lens 214. This helps reducing the overall size of the system, as shown in FIG. 6C.

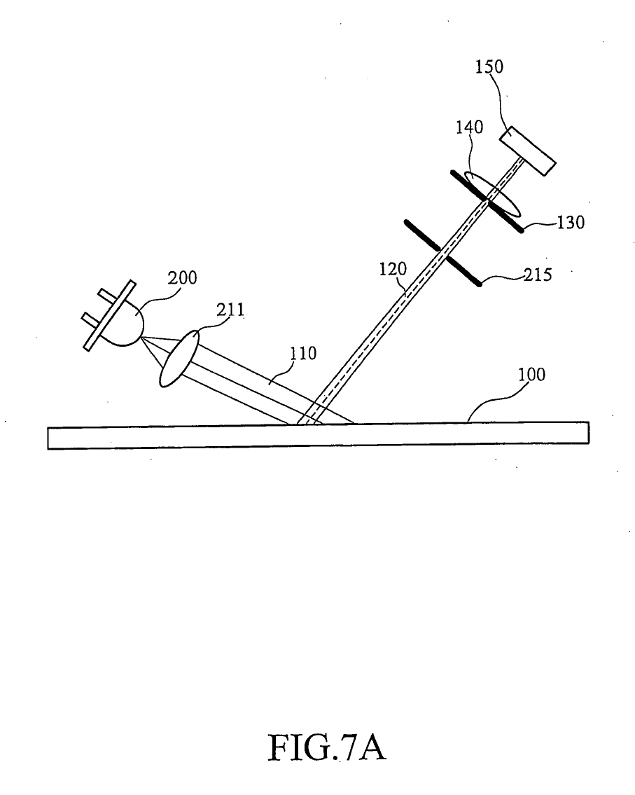

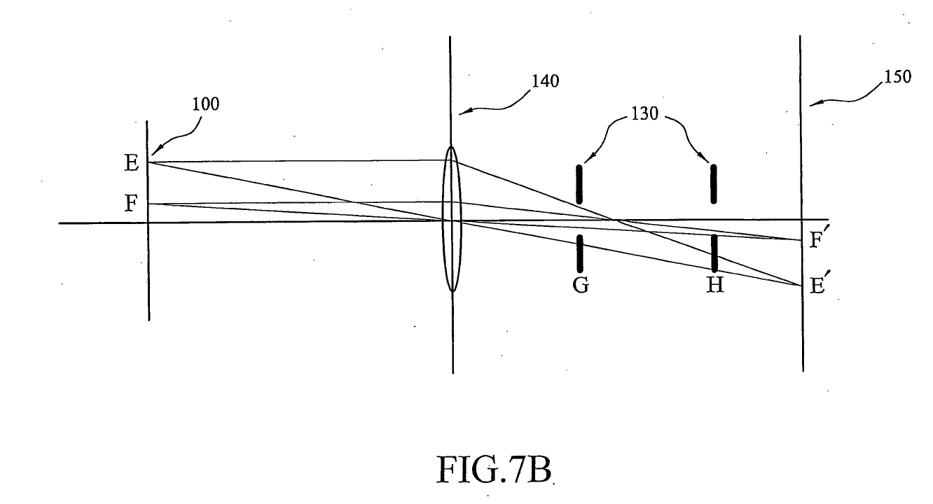

With reference to FIG. 7A, in addition to manipulating the beam near the light source 200, it is also feasible to manipulate the scattered lights 120. More explicitly, before the scattered lights 120 enter the lens 140 and the aperture 130, a secondary aperture 215 is disposed. The secondary aperture 215 first blocks part of the scattered lights 120, allowing only a certain part of the scattered lights 120 to pass through. The field-of-view of the image sensor is thus reducing by the secondary aperture 215.

Referring to FIG. 7B, two object points E and F in the surface 100 are chosen as the reference points. The scattered lights from points E and F are passing through the aperture 130, the lens 140 and should finally focus to points E′ and F′, respectively, on the image sensor 150. By using the ray tracing, we recognize that both scattered lights from points E and F will focus on the image sensor 150 if the aperture 130 is at the position G. If the aperture 130 is at the position H, only scattered light from point F will focus on the image sensor 150. Thus, by properly adjusting the diameter and position of the aperture 130, the speckle size may be enlarged and the incident angle of the scattered lights 120 may be limited.

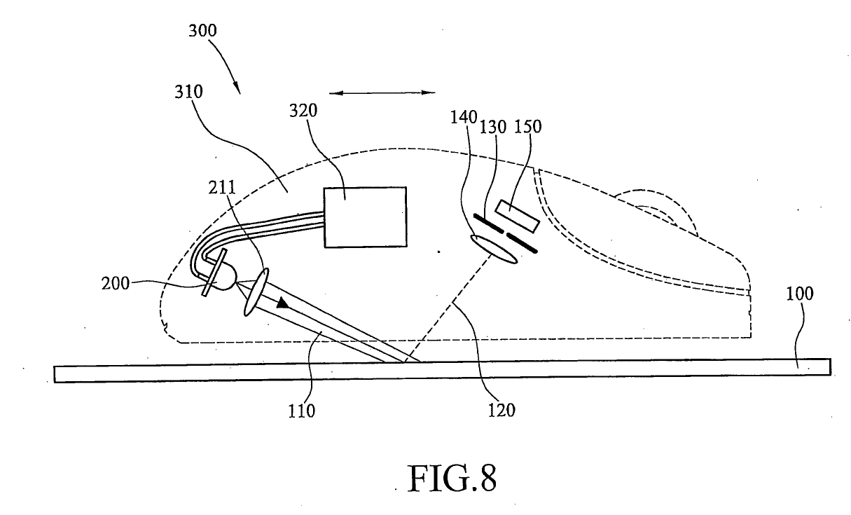

The disclosed device and method for capturing speckles may be applied to optical mouse 300, as shown in FIG. 8. The light source 200 and the image sensor 150 are both installed inside the case 310 of an optical mouse 300. The beam emitted from the light source 200 is converged by a convergent lens 211 and project onto a surface 100, from which the scattered lights 120 goes through a lens 140 followed by a small aperture 130 and finally imaged onto an image sensor 150 and then transmitting to a process unit 320. A first speckle image is recorded with the image sensor 150 before the case 310 moves and the second speckle image is then recorded with the process unit 320 with the case 310 moves relative to the surface 100. By the processing unit 320, the correlations between the first and second speckle images, magnitude and direction of the displacement of the case 310 relative to the surface 100 are determined for the motion of the cursor in the computer.

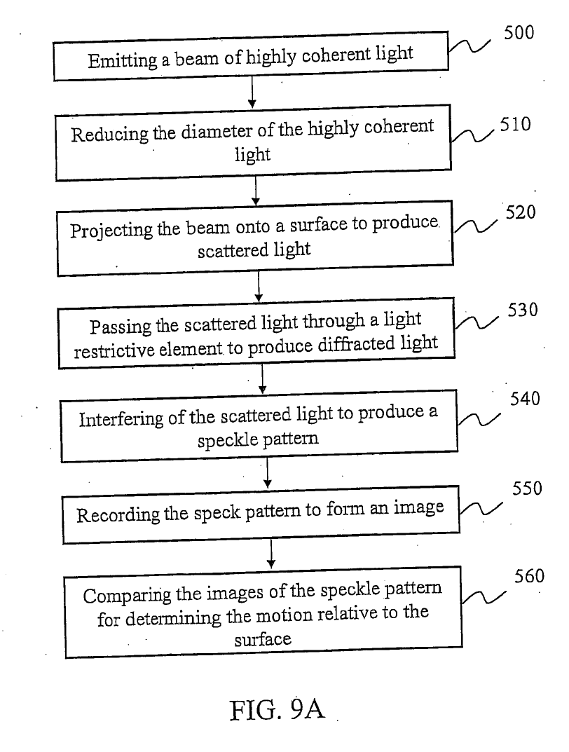

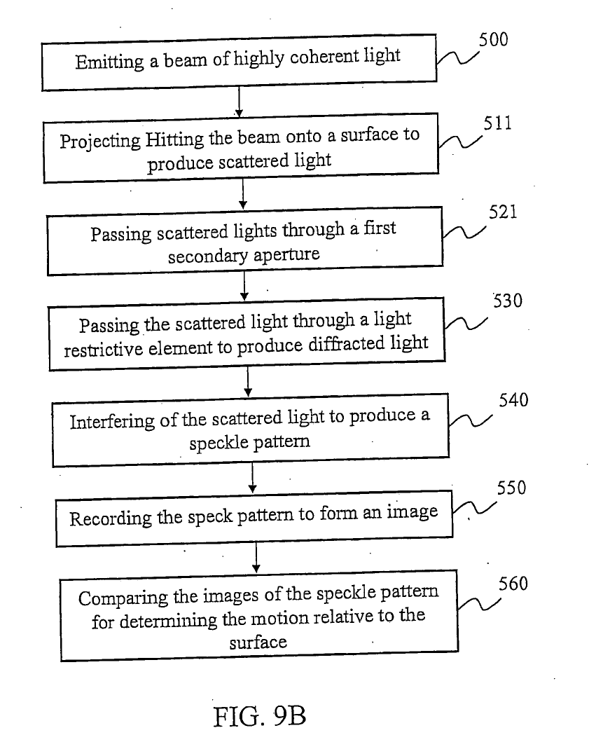

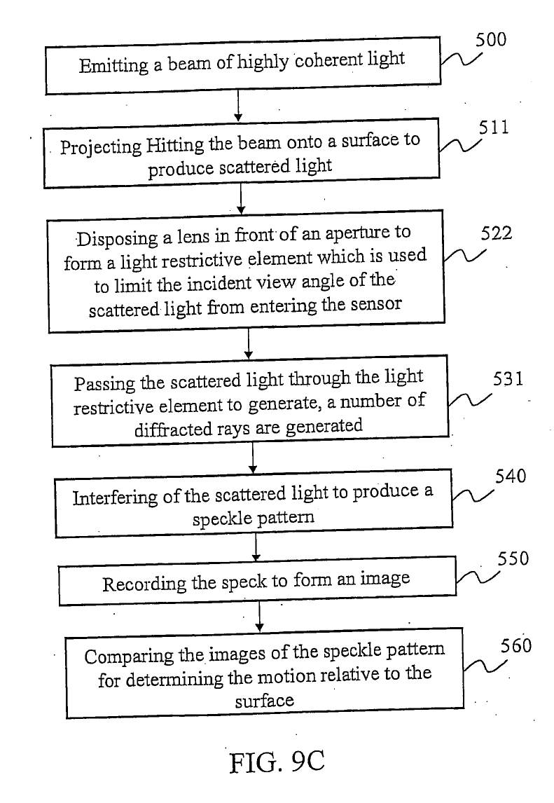

With reference to FIG. 9A, the speckle pattern imaging method starts by emitting a beam of highly coherent light (step 500). After the diameter of this highly coherent light is reduced (step 510), the light projects onto a surface to produce scattered lights (step 520).

The scattered lights pass through a light restrictive element to produce diffracted lights (step 530). The diffracted lights result interference to produce a speckle pattern (step 540). The images of the speckle patterns are recorded (step 550). The motion of the sensor relative to the surface is then determined by comparing the images of the speckle patterns (step 560).

With reference to FIG. 9B, another embodiment starts by emitting a beam of highly coherent light (step 500). The highly coherent light projects onto a surface to produce scattered lights (step 511). The scattered lights pass through a first aperture (step 521). The scattered lights further pass through a secondary aperture, the field-of-view angle of the image sensor is limiting by the secondary aperture and the secondary aperture also serves as a light restrictive element. The diffracted lights are produced when the scattered lights pass through the light restrictive element (step 530). The diffracted lights interfere with one another to produce a speckle pattern (step 540). The images of the speckle patterns are recorded during the consecutive motion of the sensor's housing relative an object surface (step 550). The relative motion is then determined by comparing the consecutive images of the speckle patterns (step 560).

Referring to FIG. 9C, the speckle imaging method starts from emitting a beam of highly coherent light (step 500). The highly coherent light is then projecting onto a surface to produce scattered lights (step 511). A light restrictive element, includes an aperture and a lens with the lens being disposed in front of the aperture, is used to limit the incident angle of the scattered lights (step 522). By passing the scattered lights through the light restrictive element, a number of diffracted light waves are generated (step 531). The diffracted lights interfere with one another to produce a speckle pattern (step 540). The images of the speckle patterns are recorded during the consecutive motion of the sensor's housing relative an object surface (step 550). The motion relative to the surface is then determined by comparing the images of the speckle patterns (step 560).

In summary, the invention provides a method and device for capturing speckles. By disposing a light restrictive element in front of the image sensor, the speckles could be enlarged and the variation of the speckle pattern will be reducing for the convenience of measurement of the relative motion of the speckle patterns. Therefore, it is fairly easy to determine the relative motion of the speckle patterns. The invention may be applied to an optical mouse to detect the motion of the mouse with high accuracy and sensitivity. Besides, the disclosed method and device for capturing speckles may be applied to a number kind of surfaces.

While the invention has been described in conjunction with specific embodiments, it is evident to those skilled in the art that many alternatives, modifications, and variations will be apparent in light of the foregoing description. Accordingly, the invention is intended to embrace all other such alternatives, modifications, and variations that fall within the spirit and scope of the appended claims.

What is claimed is:

1. A speckle imaging device, comprising:
a light source, which emits a beam of highly coherent light to be projected onto a surface and to produce a plurality of scattered lights;
a light restrictive element, which limits the incident angle of the scattered lights and produces a plurality of diffracted lights so that the diffracted lights interfere with one another to produce a plurality of speckles; and
an image sensor, which receives the speckles to generate a first speckle image;
wherein a second speckle image is generated after the light restrictive element and the image sensor have moved with respect to the surface, and the direction and distance of the motion are determined by comparing the first speckle image with the second speckle image.

2. The speckle imaging device of claim 1, wherein the light restrictive element is a microlens disposed in front of the image sensor for forming the image of the speckle in the image sensor and for the scattered lights to produce the diffracted light.

3. The speckle imaging device of claim 1 further comprising a light block plate around the microlens for blocking unnecessary scattered lights.

4. The speckle imaging device of claim 1, wherein the light restrictive element includes an aperture and a lens, the lens being disposed in front of the aperture and because of the spatial filter effected by the aperture, the incident angle of the scattered light being limited, and when the scattered lights passing through the aperture and diffracted by the aperture, the diffracted lights interfering with one another to produce the speckles forming an image on the image sensor.

5. The speckle imaging device of claim 1, wherein the light restrictive element includes an aperture and a lens with the aperture being disposed in front of the lens, and when the scattered lights passing through the aperture and diffracted by the aperture, the diffracted lights interfering with one another to produce the speckles forming an image on the image sensor.

6. The speckle imaging device of claim 5 further comprising a secondary aperture disposed on the side of the aperture facing the surface, wherein the secondary aperture and the aperture limit the field-of-view of the image sensor.

7. The speckle image device of claim 1 further comprising a beam reducing unit which is a convergent lens disposed in front of the light source for converging the high coherent light to a convergent beam.

8. The speckle imaging device of claim 1 further comprising a lens system disposed in front of the light source for converting the highly coherent light into a collimated beam.

9. The speckle imaging device of claim 8 further comprising a beam reducing unit for reducing the diameter of the beam of highly coherent light emitted by the light source.

10. The speckle imaging device of claim 9, wherein the beam reducing unit includes a first convergent lens and a second convergent lens with focal points coincidence to reduce the beam diameter of highly coherent light.

11. The speckle imaging device of claim 9, wherein the beam reducing unit includes a first lens and a third lens whose focal points coincide and the third lens is a divergent lens so that the beam of highly coherent light is reduced in diameter.

12. An optical mouse, comprising:
a light source, which emits a beam of highly coherent light to be projected onto a surface to produce a plurality of scattered lights;
a light restrictive element, which produces a plurality of diffracted lights from the scattered lights so the diffracted lights interfere with one another to produce a plurality of speckles;
a image sensor, which receives the diffracted lights and generates a first speckle image before the movement of the image sensor and a second speckle image after the movement of the image sensor with respect to the surface; and
a processing unit, which receives and compares the first speckle image and the second speckle image to determine the direction and distance of the displacement of the light restrictive element and the image sensor.

13. The optical mouse of claim 12, wherein the light restrictive element includes an aperture and a lens with the lens being disposed in front of the aperture so that the incident angle of the scattered light is limited by the aperture and the diffracted lights are produced by the scattered lights, and the diffracted lights interfere with one another to produce the speckle images in the image sensor.

14. The optical mouse of claim 12 further comprising a beam reducing unit to reduce the diameter of the beam of highly coherent light emitted by the light source.

15. A speckle capturing method, comprising the steps of:
emitting a beam of highly coherent light;
projecting the highly coherent light onto a surface to produce a plurality of scattered lights;
passing the scattered lights through a light restrictive element to generate a plurality of diffracted lights;
allowing the diffracted lights to interfere with one another to generated a plurality of speckles; and recording images of the speckles.

16. The method of claim 15, wherein the steps of recording images of the speckles is followed by the step of determining the motion of the speckle by comparing the successive pattern images that are generated during the relative movement of the image sensor and the surface.

17. The method of claim 15, wherein the step of emitting a beam of highly coherent light is followed by the step of reducing the diameter of the highly coherent light.

18. The method of claim 15, wherein the step of emitting a beam of highly coherent light is followed by the step of reducing the incident angle of the scattered light to enter the image.

19. The method of claim 15, wherein the step of projecting the highly coherent light into a surface to produce a plurality of scattered lights is followed by the step of passing the scattered lights through a secondary aperture so that the combination of the secondary aperture and the light restrictive element limit the field-of-view of the image sensor.
